(19) United States
(12) Patent Application Publication
(10) Pub. No.: US 2012/0281832 A1
(43) Pub. Date: Nov. 8, 2012

(54) SECURE WIRELESS COMMUNICATION TRANSCEIVER

(75) Inventors: Mustafa Muhammad Matalgah, Oxford, MS (US); Amer Mohammad Almaqableh, Amman (JO)

(73) Assignee: UNIVERSITY OF MISSISSIPPI, University, MS (US)

(21) Appl. No.: 13/520,215

(22) PCT Filed: Apr. 1, 2011
(86) PCT No.: PCT/US11/30952

§ 371 Date: Jul. 2, 2012

(51) Int. Cl. H04K 1/00

(52) U.S. Cl. 380/270

(57) ABSTRACT

An efficient hybrid encryption-coding algorithm is disclosed that requires using traditional encryption only for the first small amount of data. This amount of data, the first block, is determined by the traditional encryption algorithm to be applied on this first block. In this algorithm, all of the rest of the information will then be transmitted securely over the wireless channel, using network coding, without a need for using traditional encryption. Unlike the traditional and opportunistic encryption algorithms, the algorithm achieves higher data rates and less avalanche error effect, and, at the same time, it is as secure as traditional encryption algorithms. Assuming the additive white Gaussian noise (AWGN) channel model employing our disclosed algorithm, we analyze its performance in terms of throughput and security level.

### FIELD OF THE INVENTION

The present invention is generally directed toward a wireless communication transceiver. More specifically, it is directed toward a system and apparatus for a highly secure communication transmitter and receiver having higher performance in wireless communications.

### BACKGROUND OF THE INVENTION

The wireless communication link in general is insecure and open to intruders. Hence, it is vulnerable to various types of attacks where an eavesdropper can easily intercept a communication signal, alter it, and forward it to the destination or resend it back to the source. Consequently, none of the confidentiality, integrity, or authenticity of the message is preserved while traversing the wireless medium. The last decade has witnessed a tremendous increase in the number of services offered over the Internet and in the development of standards for wireless packet service. Users are more likely to have their data cross a heterogeneous internetwork. With the already evolved personal communication systems (PCS) and the advancement in wireless access to multimedia data services, PCS customer demand for wireless content has been extremely increasing. Therefore, given the insecure nature of wireless links and the Internet, wireless network security based on encryption is needed to satisfy users demand for end-to-end confidential communications.

Relay-based cooperative wireless networks have been extensively studied in the literature in the past decade. However, one deficiency in transmitting the information signal over the wireless channels, in general, and through the relay nodes in cooperative networks, in particular, is the lack of information security while the signal is traversing the wireless channel or at the relay nodes. An intruder, anywhere in the transmission path or at the relay, can easily extract the signal and recover the data with no privacy considerations.

One way to overcome this deficiency is to encrypt the data before the transmission process. However, employing encryption in relay-based cooperative wireless communication results in multiple drawbacks. First, encryption requires an extra large amount of bandwidth because of the added overhead packets. Second, the performance deteriorates extensively due to the avalanche effect ([1] and [2]) in wireless fading channels, which tremendously reduces the effective bandwidth utilization. This is in addition to the delay caused by the processing time required by the encryption and decryption algorithms at the source and destination sides, respectively. All of these drawbacks result in a large reduction in the achievable throughput. Moreover, performance deterioration, due to fades in wireless multipath fading channels, may in some extreme conditions make it almost impossible to decrypt the data at the destination side due to the avalanche effect inherited in traditional encryption algorithms. For example, and without loss of generality, in order to achieve privacy and secure communication, the transmitted data should be encrypted before transmission. The encrypted data (cipher data) can, then, be decoded at the relay side without extracting the original information (plaintext) and forwarded to the destination side. Although cryptography of the plaintext achieves security and privacy, it reduces the total throughput [2] and increases the amount of overhead bits [3]. These drawbacks motivate researchers to investigate other methods to develop effective algorithms to securely transmit information over the cooperative nodes in wireless communication. There exists a need for an encryption algorithm that is efficient for wireless communication systems.

### SUMMARY OF THE INVENTION

We disclose a hybrid encryption-network coding mechanism that minimizes the number of steps that need traditional encryption to tremendously reduce the drawbacks stated herein and to use network coding that does not suffer from performance deterioration in wireless channels as compared to traditional encryption algorithms. This work will result in a new secured communication system with high performance. Our encryption algorithm is efficient for wireless communication systems, which requires only encrypting (using traditional encryption algorithms) the first block of each frame (or superframe) of the data stream and transmits the remainder of the blocks utilizing network coding theory. This amount of data (the first block length), as well as the encryption frequency (encryption rate or the ratio of the first encrypted block-length to the length of the whole frame or superframe) is determined by the adopted traditional encryption algorithm. The size of the first encrypted block, which may vary based on the adopted encryption algorithm, is chosen according to the encryption algorithm and the key size. For example, the key size in the advance encryption standards (AES) algorithm may vary from 128, 192, and 256 bits, while the key size for the standard data encryption standard (DES) is 64 bits. Our disclosed hybrid encryption-coding algorithm is simple and achieves a pre-defined security level for the whole data frame with improved throughput and reduced overhead processing cycles. We employ a wireless channel model using this algorithm and analyze its performance in terms of overhead, security level, and system throughput. Our system achieves a predefined security level for the whole data frame with improved system throughput and reduced overhead processing cycles. At the destination end, an optimal ratio combining scheme is employed to maximize the output combined signal-to-noise ratio (SNR) to achieve the best performance at the link level (bit error probability and outage probability).

### BRIEF DESCRIPTION OF THE DRAWINGS

Further advantages of the invention will become apparent by reference to the detailed description of preferred embodiments when considered in conjunction with the drawings:

FIG. 1 depicts a diagram showing a transmitter and receiver structure for the encrypted-coded mechanism in a wireless communication system.

FIG. 2 depicts a practical implementation block diagram for the proposed encrypted-coded transceiver in wireless communication systems.

FIG. 3 depicts an exemplary superframe structure.

FIG. 4 is a graph showing a comparison between the amount of overhead processing cycles (PC) per superframe when encrypting/decrypting the superframe using the traditional AES algorithm and when using the hybrid encryption-coding algorithm at β_{c}=20.

FIG. 5 is a graph showing the overhead reduction factors for both encryption and decryption processes versus the encryption ratio, β_{c}, for the encryption-coding algorithm.

FIG. 6 is a graph showing the normalized security level and normalized throughput versus the block length for different values of the encryption ratio, β_{c} at P_{ε}=10⁻² and η=0.85.

FIG. 7 is a graph showing the comparison between the normalized throughput of BPSK using the encryption-coding algorithm, traditional AES algorithm with fixed block length, the opportunistic encryption algorithm for η=0.80, and different values of encryption ratio, β_{c}, in AWGN channel.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

We disclose the system and information signal model of our hybrid encryption-coding algorithm as follows. The source produces the information data message of a finite sequence as [m₁, m₂, . . . , m_{K}] and that are independent and identically distributed random variables that take a finite set, [symbol] , with cardinality [symbol] . We assume that the a priori probability of [symbol] (p(mᵢ), i=1, 2, . . . , K) is known, and the entropy for [symbol] is defined as

H( [symbol] )=− [symbol] p(mᵢ)log₂[p(mᵢ)]

The encryption of the data sequence [symbol] (plaintext) to generate the encrypted signal (ciphertext) [symbol] =Eₖ [symbol] , does not add any new information or change the entropy from the information theoretic viewpoint. The key used to generate the ciphertext, when using key encryption algorithms, should have an entropy of H (key)≧H ( [symbol] ) to ensure secure communication. In addition, in keyless encryption algorithms, the entropy of the randomness parameter, instead of the key, should satisfy this condition, as well. Within this model, our novel hybrid encryption-coding algorithm achieves the same security level (among the whole encrypted-coded data) as the known traditional encryption algorithms and reduces the overhead processing cycles (PC), hence increasing the achievable system throughput.

The traditional algorithm for message encryption to be used in encrypting the first block is the AES cipher algorithm (also known as the Rijndael algorithm), which is a known standard algorithm that is very immune to adversary attack by intruders, such as a brute force attacker. The encryption key is assumed to be known only to the destination node where the cipher message of the first block is received and decrypted to convey the plaintext. The AES cipher requires a 128 block size and a 128/192/256 key size that satisfies the entropy condition for the key size. The Rijndael algorithm supports many block sizes; however, the AES adopted the block size of 128 with different key lengths. The general design of the AES encryption algorithm has pre-round transformation (initial stage), R—rounds, key expansion, and a final stage. The number of rounds is determined by the key size. Particularly, the AES uses 10, 12, and 14 rounds for key sizes of 128, 192, and 256, respectively. The number of processing cycles for each operation (AND, OR, Exclusive OR (XOR), and SHIFT) varies based on the number of rounds included in the encryption algorithm as a result of different keys adopted. It should be recognized that the number of PC in the decryption is different than the number of PC used in encryption. In general, the number of PC is much larger in decryption compared to encryption.

### Embodiment 1

### Transmitter and Receiver Structures

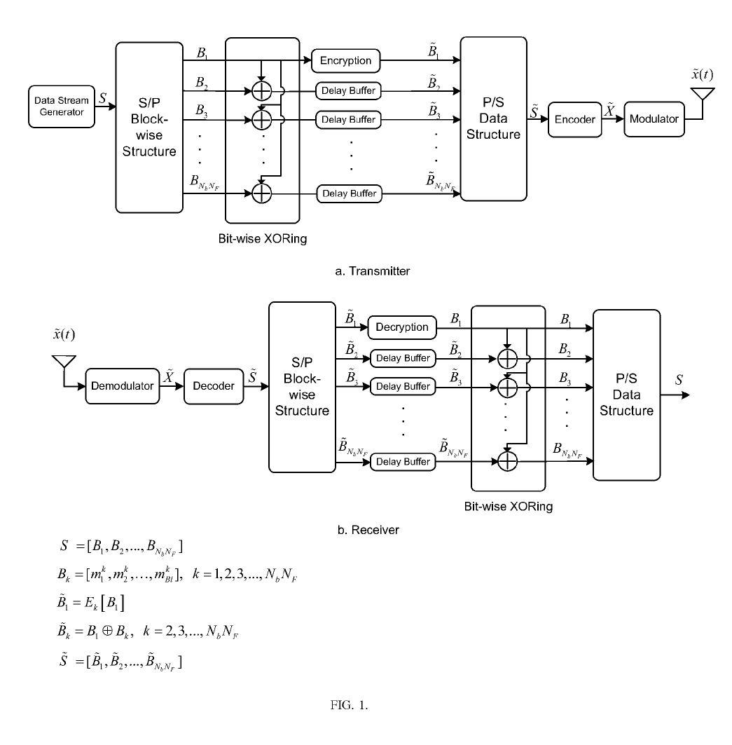

Referring to the drawings, a conceptual structure for the transceiver of the disclosed hybrid encryption-coding mechanism is shown in FIG. 1. The transmitter structure is depicted in FIG. 1a, where the incoming serial data stream (S in bits) is mapped into parallel data blocks, each with a common pre-specified block length (βₗ). Our algorithm requires that the block length βₗ be determined by the encryption algorithm that will be applied only on the first block.

The first block undergoes a proper encryption algorithm satisfying a certain security level. The remaining blocks are arranged systematically and enter a bit-wise XOR operation with the first block (before encryption, i.e., plaintext), as can be seen from the figure. Next, the data is mapped back into a serial format to be encoded before transmission (both source and channel encoding) to enhance transmission reliability. The data stream is then modulated using any digital modulation technique in order to be suitable for transmission. Without loss of generality, we consider the BPSK modulation technique to be studied in this paper, and the analysis can be generalized to any other modulation type or higher-order modulation. The receiver structure, as can be seen in FIG. 1b, completely reverses all of the operations performed at the transmitter. Also, at the receiver side, only the first block is decrypted using the appropriate traditional decryption algorithm and the decryption key, whereas, all of the other blocks are also bit-wise XORed with the first decrypted block (plaintext). As a result, all of the data frame is transmitted securely by performing traditional encryption only on the first small amount of data (B₁ in FIG. 1) within a frame or superframe.

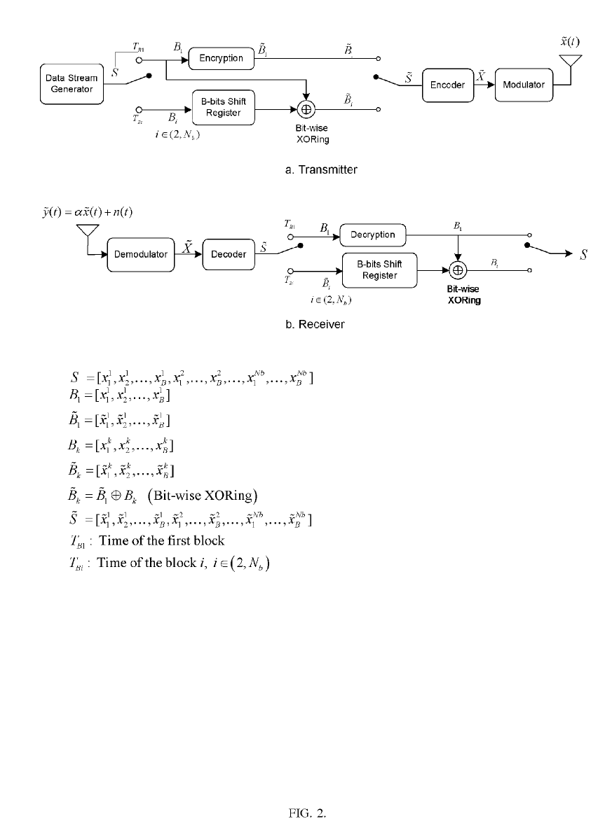

It should be appreciated that the operations performed by the bank of XOR gates along with the S/P and P/S blocks, in FIG. 1, can be practically implemented by a shift-register, one XOR gate, and a switch. However, we used the structure shown in the figure just to simplify the understanding of the concept. A practical implementation block diagram is shown in FIG. 2.

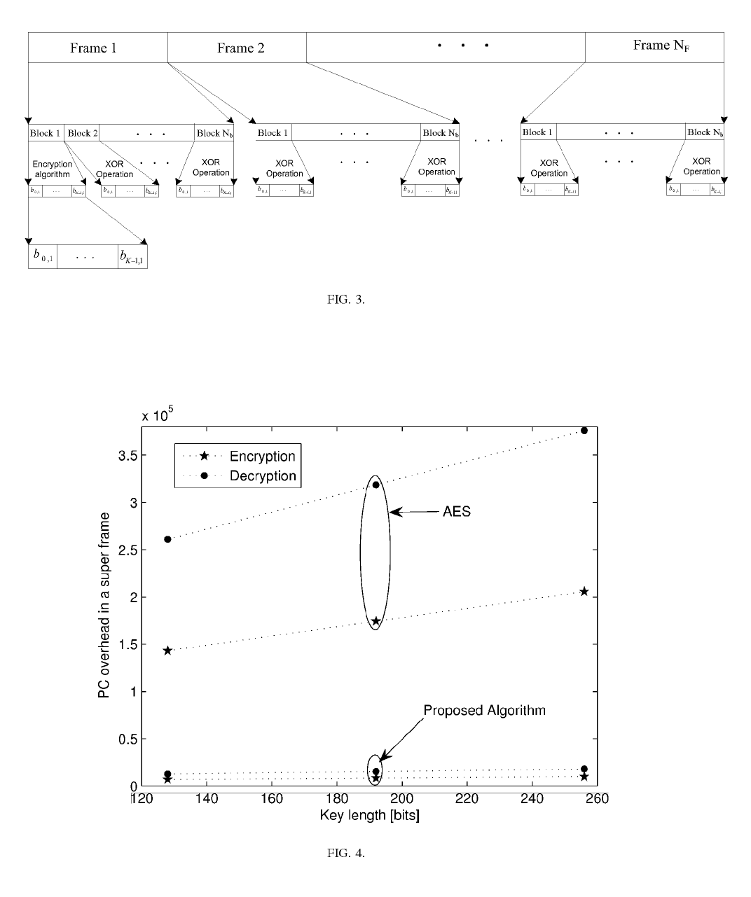

The data sequences are composed of N superframes. Each superframe contains N_{F} frames, and each frame consists of N_{b} blocks, each of K=βₗ bits size, as can be seen in FIG. 3. The encryption algorithm, for the transceiver in FIG. 1, is detailed in the text structure as Algorithm 1 below, with notations following it. As can be seen by the steps in Algorithm 1, we first encrypt the first block, B₁, with a highly immune standard traditional encryption algorithm (such as the AES). Following this step, the rest of the N_{b}−1 blocks will be used as plaintexts (i.e., will not undergo traditional encryption). In these steps that follow, a bit-wise XOR operation is performed between the plaintext of the first block with each of the remaining N_{b}−1 blocks and then transmitted to the destination. Consequently, the first block will not be recovered without performing the decryption process, which is assumed to be very immune for cryptanalysis, and, therefore, the other blocks will not be detected by the intruders since the plaintext of the first block is required to undo the XOR operation. This latter operation can be performed only after decrypting the first block (B₁) at the receiver (see FIG. 1.b). By performing the disclosed encryption algorithm, following the steps provided in Algorithm 1 and generalized for relay-based cooperative wireless networks in Table 1, where the first block is first traditionally encrypted, and, then, the XOR operation is performed for the remaining blocks with the plaintext of the first block, the whole resultant data stream will then be secure with security level as high as the security level of the first block.

The whole data stream will share the same security level since the XOR operation is a one-to-one mapping function, and the data will not be recovered by any intruder without breaking the first cipher.

For this particular embodiment, our block size was 128 bits. However, any block size can be considered in this disclosed encryption algorithm. The encryption algorithm is repeated every one superframe, or multiple of superframes, with a new encryption key. The main reason for having this algorithm repeated every superframe (N_{F} frames) is that using a new key for each superframe enhances security and reliability of the transmission.

Input: Data stream as plaintext
Output: Data stream as ciphertext
Divide the data sequence into N superframes;
foreach Nᵢ superframe (SFᵢ), i − 1,... ,N, to be sent do
| Divide each superframe into N_{F} frames;
| Divide the frame (Fₖ), k = 1,... , N_{F}, into N_{b} blocks with block size of K = βᵢ;
| Encrypt the first block B [symbol] with an appropriate encryption algorithm, i.e., \tilde{B}₁ = Eₖ |B₁|
| foreach of the remaining blocks Bⱼ, j ∈ {2,N_{b}} do
| | [symbol] _{i,j} = b_{i,j} [symbol] b_{i,} [symbol] i ⊂ {0,K 1};
| | Generate the coded blocks as \tilde{B}ⱼ = [symbol] _{U,j},... , b̅_{K-} [symbol] _{,j}] ;
| end
| Generate the encrypted-coded frame.
end
Generate the encrypted-coded superframe. Repeat for other superframes;

Algorithm 1: Generating secure encrypted-coded data using the proposed encryption algorithm

Algorithm Notations

Bⱼ : The j^{th} block of data (plaintext).
\tilde{B}ⱼ : The j^{th} block of the encrypted-coded data (ciphertext).
βₗ : block length.
N_{F} : Number of frames within a superframe.
N_{b} : Number of block within a frame.
b_{i,j} : The i^{th} bit of the j^{th} block of the data (plaintext).
\tilde{b}_{i,j} : The i^{th} bit of the j^{th} block of the encrypted-coded data (ciphertext). [symbol]
indicates data missing or illegible when filed

TABLE I
Steps Used in Performing the Proposed Algorithm in Relay-Based
Cooperative Wireless Communication Systems

| Step | Time | S (T_{∞}) | R [symbol] , i = 1,2 (R_{∞}) | D (R_{∞}) |
|---|---|---|---|---|
| 1 | Divide the superframe into N_{F} frames | NA | NA | NA |
| 2 | Divide each frame into N [symbol] blocks | NA | NA | NA |
| 3 | Encrypt the first text block & send | \ddot{B}₁ = [symbol] ₖ{B [symbol] } | \ddot{B}₁ | NA |
| 4 | Hold | Hold | NA | Σ_{i-1,2}α_{Ri}\ddot{B}₁ |
| 5 | Encode the second block & send | \ddot{B}₂ = B₂ ⊕ B₁ | \ddot{B}₂ | NA |
| 6 | Hold | Hold | NA | Σ_{i=1,2} α_{Ri}\ddot{B}₂ |
| 7 | . | . | . | . |
| | . | . | . | . |
| | . | . | . | . |
| 8 | Encode the (N_{b}N_{F})^{th} block & send | \ddot{B}_{N}_{b}N_{F} = B_{N}_{b}N_{F} ⊕ B₁ | \ddot{B}_{N}_{b}N_{F} | NA |
| 9 | Hold | Hold | NA | Σ_{i=1,2} α_{Ri}\ddot{B}_{N}_{b}N_{F-1} |
| 10 | Start over from step 1 to 9 | . | . | . |
| | for the remaining superframes | . | . | . |
| | | . | . | . |

[symbol]

indicates data missing or illegible when filed

The encryption ratio (β_{c}), can be defined as the ratio of the overall ciphertext using the XOR operation to the encrypted text using traditional algorithms. Mathematically this can be expressed as:

$$\begin{matrix}{β}_{c} = \frac{Encrypted \text{-} coded text using the XOR}{Encrypted text using traditional algorithms} \\ = \frac{( {N}_{F} {N}_{b} - 1 ) {B}_{l}}{{B}_{l}} - ( {N}_{F} {N}_{b} - 1 ) ,\end{matrix} \qquad ( 1 )$$

where N_{F}, N_{b}, and Bₗ are as defined earlier. This parameter reveals the amount of overhead processing cycles reduction when using the disclosed algorithm. As a result, as the value of β_{c} increases, the throughput increases, and the overhead decreases, for a given superframe of data. This metric allows for performance analysis of the disclosed methods.

The amount of overhead reduction in terms of processing cycles (PC) and the normalized throughput assuming AWGN channel model can be used as a performance metric of this embodiment. For the purpose of evaluating the performance of this disclosed method, we assume the standard AES encryption algorithm in encrypting and decrypting the first block, B₁.

Overhead Analysis.

The AES encryption algorithm is employed here to encrypt the first block of the superframe. We chose the block size to be 128 bits in accordance with the standards of the AES encryption algorithm [4], and hence different key sizes of 128, 192 and 256 bits can be used.

The AES algorithm is a series of different numbers of operations that include ANDs, XORs, and Shifting of bits. The AES algorithm is not symmetric algorithm in terms of number of operations during the encryption and decryption processes. In fact, the number of operations in the decryption process is much larger than the number of operations in the encryption process. For an AES algorithm with a block size of 128 bits, the total number of byte-wise processing cycles (PC) in the encryption process of a block, T_{E.B.}, was found to be:

T_{E.B.}=[256T_{AND}+136T_{XOR}+352T_{shift}](R−1)+64T_{AND}+44T_{X0R}+12T_{shift}, (2)

and for the decryption process, T_{D.B.}, the number of PC is given by

T_{D.B.}=[644T_{AND}+500T_{XOR}+224T_{shift}](R−1)+64T_{AND}+44T_{XOR}+12T_{shift}, (3)

where T_{AND}, T_{XOR}, and T_{shift} denote the number of processing cycles required for performing byte-wise operation of AND, XOR, and shift, respectively, and R is the number of rounds in the AES algorithm that depends on the key length. Then, the total number of PC overhead when encrypting a superframe using the AES algorithm, T_{E.S,F.}, becomes

T_{E.S.F.}=(β_{c}+T_{E.B.} (4)

and for the decryption process, T_{D.S.F}, it becomes

T_{D.S.F.}=(β_{c}+1) (5)

On the other hand, the disclosed hybrid encryption-coding algorithm requires only a 16 byte-wise XOR operation resulting in a total number of PC in a superframe as

T_{E,Proposed Algorithm}=T_{E.B.}+16β_{c}T_{XOR} (6)

and for decryption, we have

T_{D,Proposed Algorithm}=T_{D.B.}+16β_{c}T_{X0R}. (7)

Unlike the AES, the disclosed encryption-coding algorithm does not increase the PC overhead for any block other than the first one. It is of significant importance here to introduce a new metric, overhead reduction factor, defined as

$${O . H}_{} = \frac{Processing cycles in the disclosed algorithm}{Processing cycles in AES algorithm} \qquad ( 8 )$$

For the encryption process, this factor is

$${O . H . E .}_{} = \frac{1}{{β}_{c} + 1} + \frac{16 {β}_{c}}{( {β}_{c} + 1 ) {T}_{E . B .}} {T}_{XOR} \qquad ( 9 )$$

and for the decryption process, a similar equation for this factor is obtained except for T_{D.B.} instead of T_{E.B.} as follows:

$${O . H . D .}_{} = \frac{1}{{β}_{c} + 1} + \frac{16 {β}_{c}}{( {β}_{c} + 1 ) {T}_{D . B .}} {T}_{XOR} . \qquad ( 10 )$$

In the numerical results, we assume that the number of PC for all of the logical operations is the same, i.e., T_{AND}=T_{XOR}=T_{SHIFT}=Tₒ. Using this assumption, the overhead reduction factors for the encryption and decryption processes, respectively, become

$$\begin{matrix}{O . H . E .}_{} = \frac{1}{{β}_{c} + 1} + \frac{2 {β}_{c}}{( {β}_{c} + 1 ) [ 93 R - 78 ]} , & ( 11 ) \\ {O . H . D .}_{} = \frac{1}{{β}_{c} + 1} + \frac{2 {β}_{c}}{( {β}_{c} + 1 ) [ 171 R - 156 ]} . & ( 12 )\end{matrix}$$

The results in (11) and (12) represent the amount of overhead reduction considering the disclosed algorithm in both encryption and decryption processes, and they will be used to obtain the overhead performance curves in the numerical results section.

Throughput and Security Level.

As we indicated earlier, in any encryption algorithm, the security level is obtained at the cost of reduced achievable throughput, and, hence, this tradeoff should be considered in evaluating any security algorithm. The security level is directly proportional to the block length of the encrypted message, whereas the throughput is inversely proportional to the block length because of the associated overhead data and the fact that the block might be completely dropped due to avalanche effect in wireless channels.

In general, the security level can be defined as the amount of computational analysis required by a cryptanalysis to break down the algorithm and decrypt the cipher. The Brute force method (trying all the possible combinations for the key) to decrypt the cipher is usually used when describing the security level of any encryption algorithm. There are 2^{key length} combinations considering the Brute force attack to break the cipher, and, therefore, the security level (S_{N}) for a block text with a block length (B₁) can be mathematically formulated as [2]

S_{N}=log₂[Bₗ] (13)

Assuming the bit error probability is pₑ, the probability of receiving a block of length Bₗ bits correctly is (1−pₑ)^{B}^{ₗ}. Consequently, the throughput ( [symbol] ) can be defined as the number of correctly received bits (carrying information) per second, which can be written mathematically in terms of the bit rate ( [symbol] ) as

[symbol]

= [symbol] (1−pₑ)^{B}^{ₗ} (14)

As shown in FIG. 3, the whole superframe consists of N_{F} frames, and each frame consists of N_{b} blocks. This superframe is encrypted in two steps. First, encrypting the first block using an AES with one key, and all of the remaining blocks are encoded via a bit-wise XOR operation with the first block (plaintext) yielding a full encrypted-coded superframe with the same security level as the first block. Then, the overall achievable security level can be given as

$$\begin{matrix}\overline{S} = \frac{1}{{S}_{Max}} {\sum }_{i = 1}^{{N}_{F} {N}_{b}} {S}_{i} \\ = S \\ = {log}_{2} [ {B}_{l} ] ,\end{matrix} \\ where {S}_{i} = {S}_{first block} = S . \qquad ( 15 )$$

The average throughput can be obtained by averaging the throughput amounts of all of the blocks within one superframe (since one encryption algorithm is used for the whole superframe) as follows:

$$\begin{matrix}= \begin{matrix}1 \\ {N}_{F} {N}_{b}\end{matrix} {\sum }_{i = 1}^{{N}_{F} {N}_{b}} {i}_{} {( 1 {p}_{i} )}^{{B}_{l}} \\ = \frac{1}{{N}_{F} {N}_{b}} [ {1}_{} {( 1 - {p}_{1} )}^{{B}_{l}} + {\sum }_{i = 2}^{{N}_{b} {N}_{F}} {i}_{} {( 1 - {p}_{i} )}^{{B}_{l}} ] \\ = \frac{1}{( {β}_{c} + 1 )} [ {1}_{} {( 1 - {p}_{1} )}^{{B}_{l}} + {\sum }_{i = 2}^{( {β}_{c} + 1 )} {i}_{} {( 1 - {p}_{i} )}^{{B}_{l}} ]\end{matrix} \qquad ( 16 )$$

The results in (15) and (16) are used to obtain the performance behavior curves for the security level and the normalized throughput at a certain error rate probability. Assuming a BPSK modulation technique with coherent detection to be used during the transmission over the AWGN channel, it is well-known that pᵢ=Q (√2γ) where γ is the average signal-to-noise-ratio (SNR) per bit (see, e.g., [5]-[7]). We also assume that same data rate is shared among all blocks excluding the first block, i.e., [symbol] − [symbol] , i≧2 which is a valid assumption. However, the effective data rate for the first block is assumed to be [symbol] =η [symbol] , where η<1 because of the overhead associated with the AES encryption used for the first block. Then, it is straightforward to show that the throughput expression in (16) reduces to

$${( \frac{{β}_{c} + η}{{β}_{c} + 1} ) [ 1 - 𝒬 ( \sqrt{2 γ} ) ]}^{{B}_{l}} . \qquad ( 17 )$$

The expression in (17) will be used in the numerical section to obtain the throughput performance curves considering the disclosed encryption-coding algorithm in the AWGN wireless channel.

Results

A comparison between the overhead processing cycles of the conventional AES algorithm and the disclosed algorithm is presented in FIG. 4 for both encryption and decryption processes at β_{c}=20. As can be seen, the amount of overhead increases linearly as the key length increases for both processes. A significant overhead difference can be observed for the case of our disclosed algorithm as compared to the tradition AES algorithm.

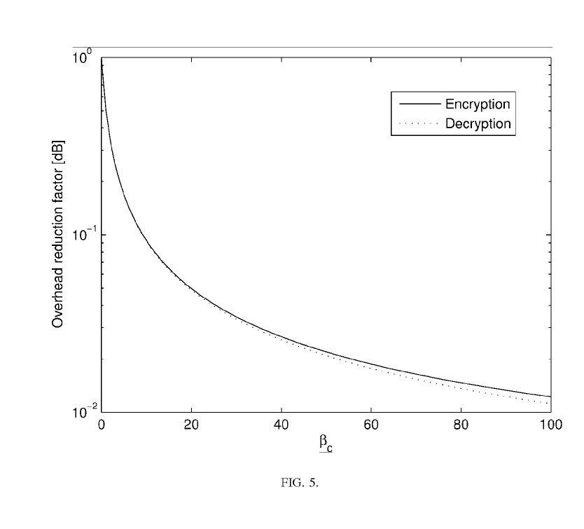

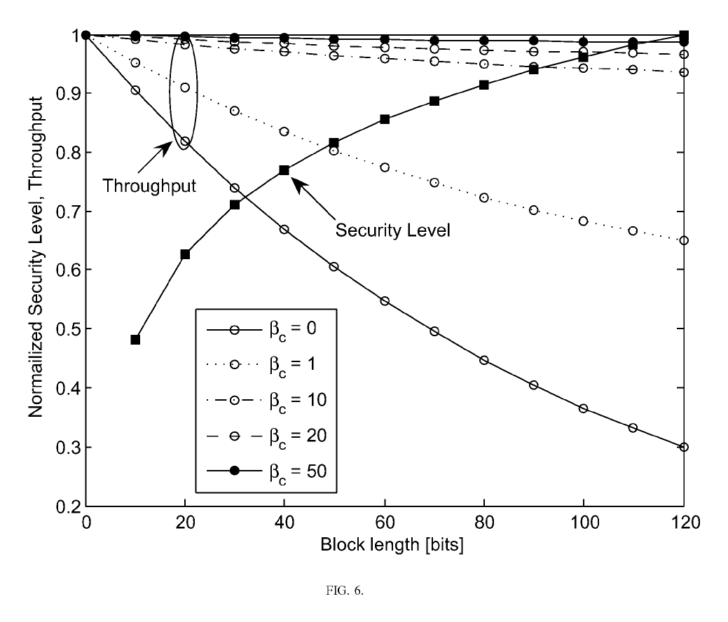

Unlike the AES algorithm, the increment in the overhead processing cycles for our disclosed algorithm is negligible when the key length increases. Additionally, as previously explained, there is a large difference for the overhead processing cycles between the decryption and encryption algorithms, as expected. FIG. 5 presents the reduction factor in the overhead processing cycles in both processes versus the encryption ratio, β_{c}, at R=10. It should be appreciated that the reduction factor is a fastly decreasing function of the encryption ratio. These observations point out the trade-off between the security level and the overhead processing cycles.

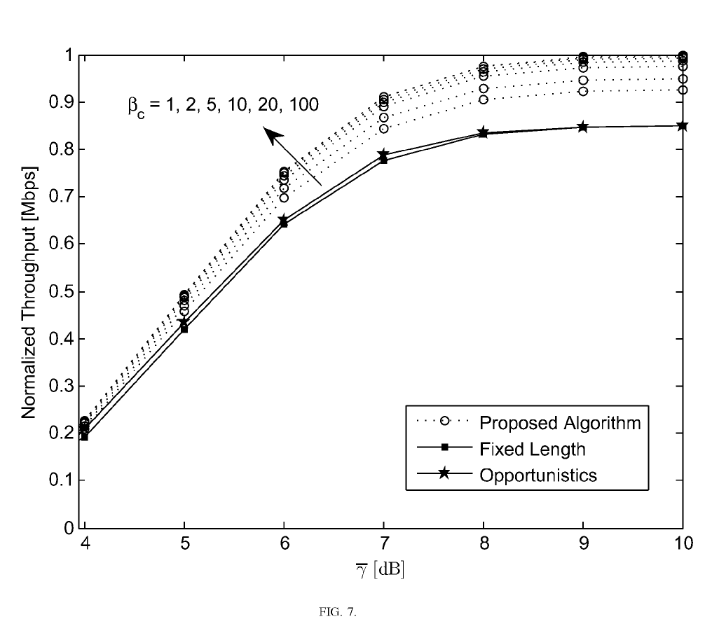

The normalized security level and the normalized throughput versus the block length for different values of encryption ratios, β_{c}, and for a fixed error probability are shown in FIG. 6. As can be observed from the curves, the normalized throughput increases as the encryption ratio increases. On the other hand, the security levels share the same curve for all values of the encryption ratio, β_{c}. However, a tradeoff is clearly observed between the throughput and the security level as the block length increases.

FIG. 7 provides a comparison between the disclosed algorithm, traditional AES algorithm with fixed length [4], and the opportunistic encryption algorithm [2]. The security level was maintained at log₂(128)=7 for all encryption algorithms, and the required security level was set to 0.9832. The block length for the opportunistic algorithm was chosen from the set [64, 80, 96,112,128]. As can be seen from the figure, the throughput of our disclosed algorithm out-performs the other two algorithms in the entire range of the SNR due to the fact that other algorithms require more overhead bits as the length of the superframe increases, unlike the presently disclosed algorithm. In this figure, we assume no service when the γ̅<4 corresponding to a Pₑ>10⁻² for the BPSK modulation technique.

We have disclosed a novel simple encryption algorithm and structure that embodies it that achieves a predefined security level based on AES standard for the whole data frames. The overhead processing cycles required by the disclosed algorithm are very small compared to the overhead processing cycles required by the fixed block length traditional AES encryption algorithm or the opportunistic encryption with variable block length. As a case study, we considered encrypted data with the BPSK modulation technique, and we derive a complete analysis for the throughput assuming the wireless AWGN channel model.

The terms “comprising.” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques, other than those specifically described herein, can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example, patent documents, including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

### REFERENCES

[1] J. Reason, End-to-End Confidentiality for Continuous-Media Applications in Wireless Systems, Ph.D. dissertation, UC Berkeley, December 2000.
[2] M. A. Haleem, C. N. Mathur, R. Chandramouli, and K. P. Subbalakshmi, “Opportunistic Encryption: A Trade-Off between Security and Throughput In Wireless Networks,” IEEE Transactions on Dependable and Secure Computing, vol. 4, no. 4, pp. 313-324, October-December 2007.
[3] Y. Xiao, B. Sun. H. Chen, S. Guizani, and R. Wang, “Performance Analysis of Advanced Encryption Standard,” IEEE GLOBECOM 2006, Proceedings of the IEEE Global Telecommunication Conference. Digital Object Identifier 10.1109/GLOCOM.2006.285, pp. 1-5, Nov. 27-Dec. 1, 2006.
[4] Behrouz A. Forouzan, Introduction to Cryptography and Network Security, McGraw-Hill, 2007.
[5] S. Haykin, Digital Communications. New York, N.Y.: John Wiley, 1988.
[6] J. Proakis, Digital Communications, 3rd ed. New York, N.Y.: McGraw-Hill, 1995.
[7] B. P. Lathi and Zhi Ding, Modern Digital and Analog Communication Systems, 4th ed. Oxford University Press: New York 2009.

We claim:

1. A method of encryption wherein the amount of data in the first block is determined using traditional encryption algorithms, and subsequent blocks are transmitted using network coding.

2. A device incorporating the method of encryption of claim 1.
